(19) United States
(12) Patent Application Publication
(10) Pub. No.: US 2008/0147595 A1
(43) Pub. Date: Jun. 19, 2008

(54) SELF-PROTECTING DATABASE TABLES

(75) Inventor: Walid Rjaibi, Markham (CA)

Correspondence Address: Kunzler & McKenzie, 8 EAST BROADWAY, SUITE 600, SALT LAKE CITY, UT, 84111, US

(73) Assignee: INTERNATIONAL BUSINESS MACHINES CORPORATION, ARMONK, NY (US)

(21) Appl. No.: 11/611,734

(22) Filed: Dec. 15, 2006

(51) Int. Cl. G06F 17/30; H04K 1/00

(52) U.S. Cl. 707/2; 726/1

(57) ABSTRACT

An apparatus and method for adding a layer of security to a database table includes assigning a self-protection policy to a selected database table. One or more monitoring attributes are designated for inclusion in the self-protection policy. These monitoring attributes include one or more conditions that, if satisfied either alone, in the alternative, or in combination, may be an indicator that an intruder has acquired or is attempting to acquire access to the database table. One or more reactive measures may also be selected for inclusion in the self-protection policy. These reactive measures specify one or more actions to be performed in the event the one or more conditions are satisfied.

### BACKGROUND OF THE INVENTION

1. Field of the Invention

This invention relates to databases and more particular to apparatus and methods for securing database tables.

2. Description of the Related Art

Tables are the database objects used to store one of an organization's most valuable assets—information. However, database tables are typically passive entities which are unable to defend themselves. Consequently, they typically rely on database access control systems to protect the data they store. While access control is an important aspect of database security, it is typically inadequate to defend against a variety of threats or actions which may compromise data security.

For example, where masquerading occurs, a masquerader may have free rein to exploit the account of a legitimate user or administrator. Access control systems are powerless against masquerading because they cannot distinguish between the masquerader and the real user or administrator. Although intrusion tolerance countermeasures can be deployed to repair damage caused by a masquerader, they cannot prevent the masquerader from retrieving data.

Anomaly-based intrusion detection techniques may theoretically detect the masquerader if his or her behavior deviates sufficiently from a real user. Unfortunately, the average detection latency is often too long to detect and stop a masquerader from retrieving unauthorized data in real time. Moreover, intrusion detection has received very little attention from the database research community, and almost complete disregard from commercial database products.

Masquerading can occur in a variety of ways including password theft, SQL injection, and software vulnerability exploitation. Password theft is a common occurrence that allows an attacker to gain access to a legitimate user's password using techniques such as keystroke logging, bogus password entry screens, and traffic monitoring. Password theft may also be accomplished using less sophisticated techniques such as searching for passwords taped to monitors, under keyboards, or in the top drawers of users who are unable to remember the lengthy passwords required by many organizations.

SQL injections are simple yet powerful in the sense that they enable an attacker to issue arbitrary SQL statements (e.g., select user credentials from the USERS tables) by taking advantage of non-validated input in a web application. As far as the database is concerned, the injected SQL is typically executed under the user ID used by the web application to connect to the database, which often has administrator privileges. In other situations, an attacker may gain access to a database (often with administrator privileges) by exploiting a software bug.

In view of the foregoing, what is needed is an apparatus and method to convert database tables into active entities that can defend against threats such as masquerading. Ideally, such an apparatus and method would be able to fill in the security gaps of conventional database access control systems.

### SUMMARY OF THE INVENTION

The present invention has been developed in response to the present state of the art, and in particular, in response to the problems and needs in the art that have not yet been fully solved by currently available apparatus and methods. Accordingly, the present invention has been developed to provide an added layer of security to database tables.

In one aspect of the invention, a method for adding a layer of security to a database table includes assigning a self-protection policy to a selected database table. One or more monitoring attributes may be designated for inclusion in the self-protection policy. These monitoring attributes may include one or more conditions that, if satisfied either alone, in the alternative, or in combination, may be an indicator that an intruder has acquired or is attempting to acquire access to a database table. The monitoring attributes are indicative of an atypical access pattern which may indicate that conventional security measures of a DBMS have been compromised. One or more reactive measures may also be selected for inclusion in the self-protection policy. These reactive measures may specify one or more actions to be performed in the event the one or more conditions are satisfied. The method includes a check of the monitoring attribute of the self-protection policy in an execution plan in response to a SQL access request that includes the SQL database table.

In selected embodiments, conditions that may be indicators of unauthorized access include the number of database table rows accessed by a user, the time the database table is accessed by a user, the network address of a user, the database columns accessed by a user, the application used to access the database, or the like. Similarly, reactive measures that may be taken may include revoking a user's access privileges to a database table, auditing a user, notifying a security administrator of the actions of a user, terminating a connection with a user, or the like. In selected embodiments, the self-protection policy may be created, modified, terminated, or the like using one or more SQL extensions.

In another aspect of the invention, an apparatus for adding a layer of security to a database table may include an assignment module to assign a self-protection policy to a selected database table. A monitoring module may be used to designate a monitoring attribute for inclusion in the self-protection policy. These monitoring attributes include one or more conditions that, if satisfied, may indicate possible unauthorized access to the database table. An action module may be provided to designate a reactive measure for inclusion in the self-protection policy. These reactive measures may specify one or more actions to be performed in the event the one or more conditions are satisfied. Similarly, an implementation module may be provided to determine whether a condition of a monitoring attribute for self-protection policy is satisfied and then execute the reactive measure in response to an SQL access request that includes the database table.

The present invention provides novel apparatus and methods for providing additional security to database tables. The features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through the use of the accompanying drawings, in which:

FIG. 1 illustrates one embodiment of an apparatus for adding a layer of security to a database table; and

FIGS. 2A through 2D illustrate various embodiments of SQL extensions that may be used to add a self-protection policy to a database table.

### DETAILED DESCRIPTION OF THE INVENTION

It will be readily understood that the components of the present invention, as generally described and illustrated in the Figures herein, may be arranged and designed in a wide variety of different configurations. Thus, the following more detailed description of the embodiments of the apparatus and methods of the present invention, as represented in the Figures, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, specific details may be provided, such as examples of programming, software modules, user selections, etc., to provide a thorough understanding of embodiments of the invention. One skilled in the relevant art will recognize, however, that the invention can be practiced without one or more of the specific details, or with other methods, components, etc. In other instances, well-known structures, or operations are not shown or described in detail to avoid obscuring aspects of the invention.

The illustrated embodiments of the invention will be best understood by reference to the drawings, wherein like parts are designated by like numerals throughout.

The following description is intended only by way of example, and simply illustrates certain selected embodiments of apparatus and methods that are consistent with the invention as claimed herein.

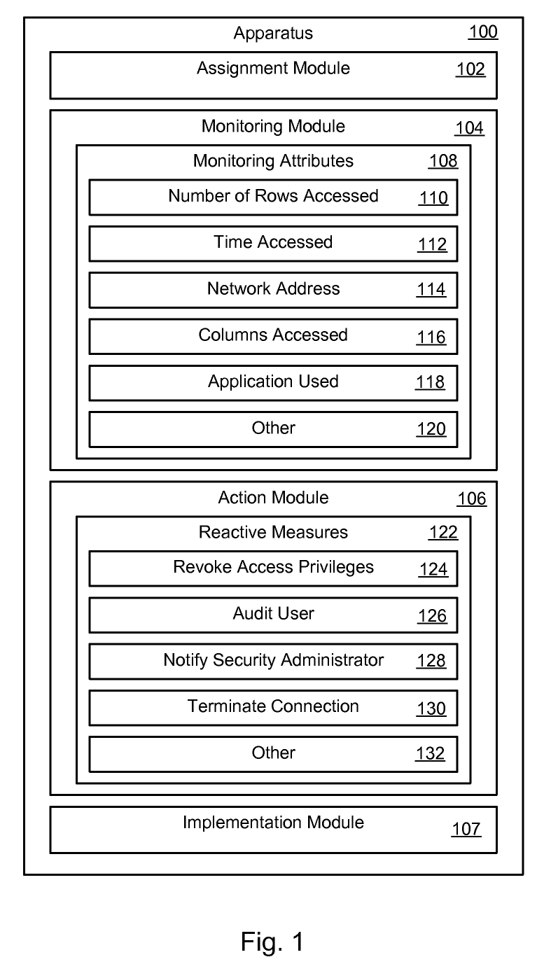

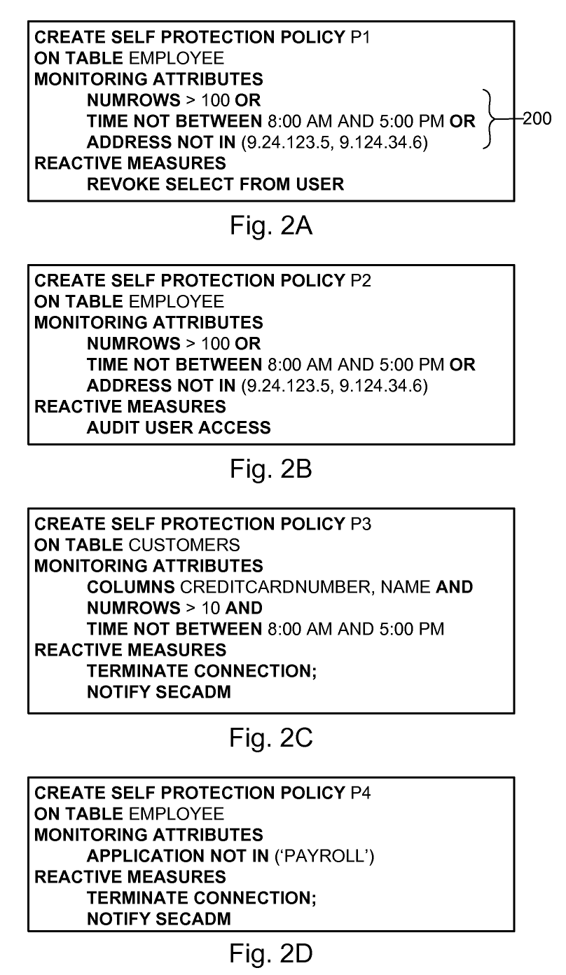

Referring to FIG. 1, one embodiment of an apparatus 100 for adding a layer of security to a database table is illustrated. It should be noted that the apparatus 100 may work independently from conventional database access control systems to convert database tables into active, self-protecting entities. It should also be recognized that the modules described herein may be implemented in a database system by introducing one or more SQL extensions for working with table self-protection policies, several examples of which will be discussed in association with FIGS. 2A through 2D. These extensions may enable a security administrator to create, alter, or drop self-protection policies with respect to selected database tables. Once a self-protection policy is defined for a table, a database system may be configured to implement a self-protection policy in the execution plan it generates when a table is accessed through an SQL statement.

In one embodiment in accordance with the invention, an apparatus 100 for converting tables into self-protecting entities may include an assignment module 102, a monitoring module 104, an action module 106, and an implementation module 107. An assignment module 102, for example, may be used to associate or assign a self-protection policy to a selected database table to provide an additional layer of security thereto. This may include, for instance, simply identifying the name or names of database tables that a user wishes to associate with a self-protection policy at the time the policy is created.

A monitoring module 104 may be used to designate one or more monitoring attributes 108 to include in a self-protection policy. These monitoring attributes 108 may include one or more conditions that, if satisfied, either alone, in the alternative, or in combination, may indicate that a masquerader or other intruder is attempting to access a database table. For example, conditions that may indicate unauthorized access to a database table may include the number 110 of rows (or records) accessed by a user in a database table (e.g., greater than 100 rows) or the time 112 of day or amount of time 112 a database table is accessed by a user (e.g., access outside of regular business hours). Other conditions may include the network address 114 of a user accessing a table (e.g., the user's IP address does not belong to an approved list of IP addresses or is outside of a range of IP addresses), the database columns 116 accessed by the user (e.g., user accesses CREDITCARDNUMBER or SOCIALSECURITYNUMBER columns), the applications 118 used to access a database, or other conditions 120 that may indicate unauthorized access.

An action module 106 may be used to designate one or more reactive measures 122 for inclusion in the self-protection policy. These reactive measures 122 may identify one or more actions that are performed in the event the one or more conditions are satisfied. For example, reactive measures 122 may include revoking 124 a user's access privileges to one or more database tables in the database or auditing 126 a user to determine the user's identity, behavior, history, or the like. Other reactive measures 122 may include notifying 128 a security administrator of the actions of a user, terminating 130 a connection between a database and a user, as well as other desired reactive measures 132.

Similarly, an implementation module 107 may be provided to determine whether a condition of a monitoring attribute for self-protection policy is satisfied in response to an SQL access request to the database table. If the monitoring attribute is satisfied, the implementation module 107 may then execute the designated reactive measures.

Referring to FIGS. 2A through 2D, several examples of self-protection policies designed to take reactive measures are illustrated. Although other implementations are possible, the illustrated self-protection polices are established using one or more SQL statements which may be implemented as extensions in SQL. For example, a statement “CREATE SELF PROTECTION POLICY” followed by a policy name may be used to create a self-protection policy. The statement ON TABLE followed by a table name may be used to associate a policy with a particular database table. Similarly, the statements MONITORING ATTRIBUTES and REACTIVE MEASURES may be used to set monitoring attributes and reactive measures respectively.

Referring to FIG. 2A, for example, a self-protection policy “P1” may be created for a database table “EMPLOYEE.” This policy causes a database system to reject any access to the EMPLOYEE table where the number of rows selected is greater than 100 rows, or the access is made outside of regular business hours, or the access is made outside of some specific IP addresses. When any of these conditions is true, the system revokes SELECT access from the user ID that accessed the table. As is illustrated by FIG. 2A, conditions 200 may be created using various Boolean operators (e.g., NOT, AND, OR) as well as other operators (e.g., >, <, =, ≠, ≦, ≧, etc.).

Referring to FIG. 2B, this example is similar to that illustrated in FIG. 2A, except that the reactive measure of the self-protection policy “P2” is to audit the user ID accessing the database table. As previously mentioned, an audit may include determining a user's identity, location, network address, behavior, access history, or the like, in an attempt to determine whether the user is an intruder or attacker. An audit may include, in some circumstances, monitoring the actions of a user prior to revoking access, terminating a connection, or taking other corrective action. In some cases, this may be performed without alerting the intruder.

Referring to FIG. 2C, in other embodiments, a self-protection policy may be created which causes a database system to reject access when a user attempts to access certain columns of a table. For example, a self-protection policy “P3” may reject access where a user attempts to access the columns CREDITCARDNUMBER and NAME from a CUSTOMERS table and the user retrieves more than 10 rows outside of regular business hours. Such an occurrence could be an attacker attempting to steal information and possibly publish it to the Internet as has happened on a number of occasions. In this example, the reactive measure is to terminate the database connection and notify a security administrator.

Referring to FIG. 2D, in other embodiments, a self-protection policy may be created to reject access where access is made (or is not made) through a designated application. For example, here the self-protection policy “P4” causes a database system to reject any access to the EMPLOYEE table not made through the PAYROLL application. The reactive measure in this example is to terminate the database connection and notify a security administrator.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product for adding a layer of security to a SQL database table independent of security measures in place for a SQL database comprising a computer useable medium including a computer readable program, wherein the computer program product when executed on a computer causes the computer to:
assign a self-protection policy to a selected SQL database table;
designate a monitoring attribute for inclusion in the self-protection policy;
wherein the monitoring attribute comprising at least one condition that, if satisfied, is an indicator of possible unauthorized access to the SQL database table;
select a reactive measure for inclusion in the self-protection policy, the reactive measure designating at least one action to be performed in the event the at least one condition is satisfied;
include a check of the monitoring attribute of the self-protection policy in an execution plan in response to a SQL access request that includes the SQL database table;
determine whether the at least one condition of the monitoring attribute for self-protection policy is satisfied; and
execute the selected reactive measure in response to the SQL access request.

2. The computer program product of claim 1, wherein the at least one condition is based on at least one of the number of SQL database table rows accessed by a user, the time the SQL database table is accessed by a user, the network address of a user, the SQL database columns accessed by a user, and the application used to access the SQL database.

3. The computer program product of claim 1, wherein the at least one action is selected from the group consisting of revoking a user's access privileges to the SQL database table, auditing a user, notifying a security administrator of the actions of a user, and terminating a connection with a user.

4. The computer program product of claim 1, wherein the self-protection policy is managed for the selected database table using SQL extensions such that an operator can create, modify, or terminate the self-protection policy.

5. An apparatus for a layer of security to a SQL database table independent of security measures in place for a SQL database, the apparatus comprising:
an assignment module to assign a self-protection policy to a selected SQL database table;
a monitoring module for designating a monitoring attribute for inclusion in the self-protection policy;
wherein the monitoring attribute comprising at least one condition that, if satisfied, is an indicator of possible unauthorized access to the SQL database table;
an action module for designating a reactive measure for inclusion in the self-protection policy, the reactive measure identifying at least one action to be performed in the event the at least one condition is satisfied; and
an implementation module configured to include a check of the monitoring attribute of the self-protection policy in an execution plan in response to a SQL access request that includes the SQL database table, determine whether a condition of a monitoring attribute for self-protection policy is satisfied, and execute the reactive measure.

6. The apparatus of claim 5, wherein the at least one condition is based on at least one of the number of SQL database table rows accessed by a user, the time the SQL database table is accessed by a user, the network address of a user, the SQL database columns accessed by a user, and the application used to access the SQL database.

7. The apparatus of claim 5, wherein the at least one action is selected from the group consisting of revoking a user's access privileges to the SQL database table, auditing a user, notifying a security administrator of the actions of a user, and terminating a connection with a user.

8. The apparatus of claim 5, wherein the self-protection policy is at least one of created, modified, and terminated using SQL extensions.
